(19) United States
(12) Patent Application Publication
(10) Pub. No.: US 2015/0093478 A1
(43) Pub. Date: Apr. 2, 2015

(54) ABSORBENT PAD TO REDUCE CONFINEMENT ODOR IN FOOD PACKAGES

(71) Applicant: Paper-Pak Industries, Laverne, CA (US)

(72) Inventors: Sayandro Versteylen, Fontana, CA (US); Brett N. Stoll, Rancho Cucamonga, CA (US); Martin H. Michaels, New York, NY (US)

(21) Appl. No.: 14/497,973

(22) Filed: Sep. 26, 2014

Related U.S. Application Data
(60) Provisional application No. 61/883,368, filed on Sep. 27, 2013.

(51) Int. Cl. A23L 1/015; A01N 37/06; B01J 20/28; B01J 20/20; B01J 20/24; A01N 37/36; A01N 25/34

(52) U.S. Cl. CPC A23L 1/0156; A01N 37/36; A01N 37/06; A01N 25/34; B01J 20/20; B01J 20/24; B01J 20/28061; B01J 20/28064; B01J 20/28066
USPC 426/124; 514/574; 514/557; 424/412; 502/416; 502/404; 435/174; 428/507; 428/481; 428/479.3

(57) ABSTRACT

An absorbent pad that contains activated carbon to reduce confinement odor in a vacuum-packaged food product is provided. An embodiment of absorbent pad contains activated carbon and an antimicrobial agent that further reduces confinement odor by two mechanisms of action: reducing bacterial counts in the liquid purge that cause breakdown of carbohydrates and proteins in food products; and trapping of confinement odor-causing breakdown products by the activated carbon. The absorbent body in the absorbent pad actively draws in liquid purge and dissolved volatile breakdown products in the vacuum package that produce confinement odor, which produces greater and more rapid contact of odor-causing compounds with the activated carbon.

### CROSS-REFERENCE TO RELATED APPLICATIONS

The present application is claiming priority of U.S. Provisional Patent Application Ser. No. 61/883,368, filed on Sep. 27, 2013, the contents of which are hereby incorporated by reference.

### BACKGROUND OF THE DISCLOSURE

1. Field of Disclosure

The present disclosure provides an absorbent pad having activated carbon to reduce the release of odor-causing volatile organic compounds (confinement odor) when a food package is opened.

2. Description of Related Art

Vacuum-packaging certain food products (such as seafood, beef, poultry, pork, and other meats, fruits and vegetables) in flexible food packages is an effective and economically-viable way to enhance the shelf life of the food product.

However, when a vacuum-packaged food product is first opened by the consumer, the initial release of volatile organic compounds from the food package can produce an unpleasant odor, called “confinement odor.” Although confinement odor usually disperses quickly after opening the package, and does not mean that the food product is unsuitable for consumption, consumers may be concerned that the food product is spoiled, or at least unappetizing, and may dispose of the food product or return it to the retailer. Confinement odor has become an obstacle to acceptance of vacuum packaging.

Confinement odor is believed to be caused (at least in part) by microbial activity acting on the food product. There are many compounds associated with tissue breakdown of food products by microbes. Carbohydrates in vacuum-packaged food products break down anaerobically into various carboxylic acids (e.g., lactic acid, acetic acid, and formic acid) and alcohols, typically ethanol. Proteins in vacuum-packaged food products break down into a number of volatile organic sulfur (sulfur, hydrogen sulfide, methanethiol, dimethyl sulfide, dimethyl disulfide, dimethyl trisulfide, and dimethyl tetrasulfide) and nitrogen (ammonia, trimethylamine, indole, cadaverine, putrescine and thiazoles). The qualitative description of the odor often depends on the food product. For beef and poultry products, confinement odor generally has a sulfurous odor, particularly where the pH is high inside the package. For other types of vacuum-packaged foods, confinement odor is described as having a cheese odor or sour milk odor.

Confinement odor is a particular problem for vacuum-packaged food products because of its special packaging requirements. A conventional food package typically uses a breathable, semi-permeable thin film that allows some of the CO₂, O₂, as well as odor-causing volatile organic compounds to gradually escape the food package. In addition, the conventional food package has a certain amount of headspace between the food product and the breathable film in which dissolved volatile organic compounds in solution can establish equilibrium in the gas phase and, from there, slowly escape the food package through the breathable film. By contrast, vacuum-packaged food products require a thicker plastic film that is largely impermeable to gases and acts as a barrier film, and does not permit the slow escape of CO₂, O₂, and volatile organic compounds out of the package. Also, vacuum-packaged food products have very little or no headspace in which any dissolved volatile organic compounds can establish an equilibrium in gas phase, and so the volatile organic compounds are trapped in the liquid until the vacuum-packaged food product is opened by the consumer, causing the dissolved volatile organic compounds to rapidly transition into a gas (analogous to opening a bottle of a carbonated beverage) and their release into the air, where these volatile compounds are perceived as confinement odors by the consumer.

Activated carbon is a solid, highly porous material that attracts, adsorbs and traps volatile organic compounds on its surface. Activated carbon attracts organic compounds from gas and liquid streams, and so is commonly used in filters as an economical way to remove organic contaminants from large volumes of air or water. The primary use for activated carbon is treatment of water, including potable water, wastewater, and groundwater remediation. On a smaller scale, activated carbon filters are used in fish tanks to remove chemical impurities in the water. As another example, activated carbon is used in air filters to remove chemical impurities in the air.

Activated carbon is generally safe for human ingestion, and has been used as an odor-removing, color-removing, and taste-removing agent in food processing.

Activated carbon largely adsorbs, as opposed to absorbs, molecules of organic compounds. Adsorption is a process by which molecules adhere to the surface only. Absorption, by contrast, is analogous to a sponge that soaks up water, in which the absorbed water is fully integrated into the sponge. Activated carbon has a very large surface area and pore volume that gives it a unique adsorption capacity. Commercial grade activated carbon for food products has a surface area that ranges between 300 and 2,000 m²/g, with some having surface areas as large as 5,000 m²/g. Activated carbon adsorbs molecules of odor-causing organic compounds, for example, as these compounds “stick” to the surface of the carbon particles along this very large surface area.

Activated carbon attracts and adsorbs organic compounds much more readily than it attracts and adsorbs inorganic compounds. Hence, few inorganic compounds are removed by filters that contain activated carbon. Molecular weight, polarity, water-solubility, temperature and concentration affect the capacity of activated carbon to attract a particular compound.

In isolation, a filter containing activated carbon is “passive.” For example, if an air filter with activated carbon is placed in a closed room with odor-causing compounds in the air, the air filter will take an extraordinarily long time to remove the odor-causing compounds because so little air is drawn in contact with the activated carbon. For this same reason, activated carbon has not been considered to remove odor-causing compounds in vacuum-packaged food products.

However, if the same air filter is placed at the end of an electric fan that forces air through the air filter, the activated carbon in the air filter will rapidly remove the odor-causing compounds to quickly and completely purify the air in the room.

### SUMMARY OF THE DISCLOSURE

The present disclosure provides an absorbent pad that contains activated carbon to reduce confinement odor in a vacuum-packaged food product.

The absorbent pad can also contain an antimicrobial agent to further reduce confinement odor in a vacuum-packaged food product by reducing microbial counts in the liquid purge.

It is believed that the activated carbon and antimicrobial reduce confinement odor by two mechanisms of action. The antimicrobial kills or inhibits growth of microbes that break down carbohydrates and proteins into odor-causing compounds, reducing confinement odor. The activated carbon contacts and adsorbs any odor-causing compounds that are formed, preventing them from re-entering the gas phase and releasing into the air when the vacuum-packaged food product is opened by the consumer.

The absorbent pad architecture enhances the reduction of confinement odor by the activated carbon and antimicrobial agent by having an absorbent body that is structured to actively “draw in” the liquid purge with its dissolved odor-causing compounds, for greater contact with the activated carbon and/or antimicrobial agent, resulting in more rapid and complete reductions in confinement odor.

The absorbent pad is an economical and environmentally-friendly device to reduce or eliminate confinement odor in vacuum-packaged food products.

### BRIEF DESCRIPTION OF THE DRAWINGS

FIG. 1 is a perspective view of an exemplary embodiment of an absorbent pad of the present disclosure.

FIG. 2 is a cross-section of the exemplary embodiment of the absorbent pad in FIG. 1 taken along axis A-A through the absorbent pad.

FIG. 3 is another perspective view of the exemplary embodiment of the absorbent pad in FIG. 1.

FIG. 4 is a right side view of the absorbent pad in FIG. 3 that is cut in half along the longitudinal axis to show the interior of the absorbent pad.

FIG. 5 is a graph depicting a test of vacuum-packaged pork chops comparing an odor rating over several days for four types of absorbent pads: (1) antimicrobial laminate having activated carbon plus an antimicrobial agent (C*AM); (2) laminate with activated carbon only (C*); (3) laminate with an antimicrobial agent only (AM); or (4) a Control pad without activated carbon or an antimicrobial agent.

### DETAILED DESCRIPTION OF THE DISCLOSURE

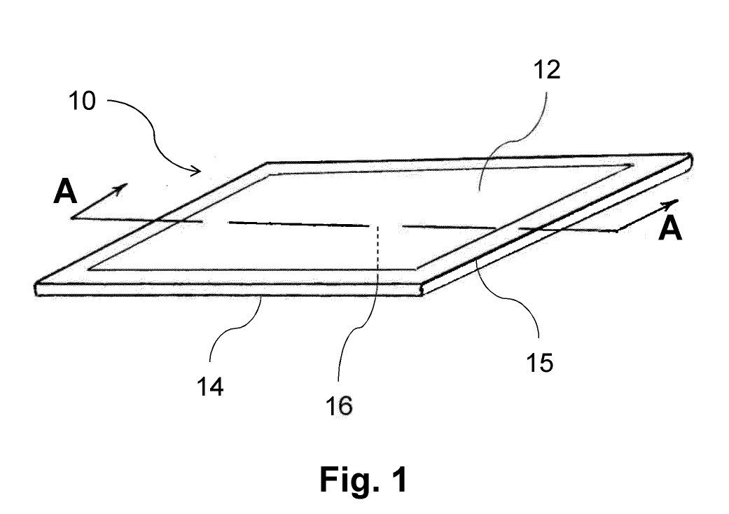

Referring to the drawings, and in particular, FIGS. 1 to 4, there is provided an exemplary embodiment of an absorbent pad or food pad generally represented by reference number 10. Absorbent pad 10 contains activated carbon, and can be placed in a vacuum-packed food package with a food product to reduce confinement odor. Absorbent pad 10 can further include an antimicrobial agent to further reduce confinement odor.

Absorbent pad 10 has a top layer 12, and a bottom layer 14 opposite top layer 12. Between top layer 12 and bottom layer 14 is an absorbent body 16 made of one or more layers of an absorbent and/or superabsorbent material. Top layer 12 and bottom layer 14 directly contact each other and are sealed at edges 15 to seal absorbent pad 10, and to enclose absorbent body 16. A laminate 19 can also be part of absorbent pad 10, and is positioned between top layer 12 and bottom layer 14.

In an alternative embodiment, absorbent pad 10 can have one or more of edges 15 that are left unsealed to form an open cell pad.

Top layer 12 is a film that is polyethylene, polypropylene, polyester, or any combinations thereof. In an exemplary embodiment, top layer 12 is a blown polyethylene film. The blown polyethylene film can have a thickness of about 0.65 mil. In another embodiment, top layer 12 is any nonwoven material. In yet another embodiment, top layer 12 is made of coffee filter tissue (CFT).

Bottom layer 14 is a nonwoven material. Examples of nonwovens for bottom layer 14 include, but are not limited to, polyolefin, polyester, or polyamide. Preferably, the nonwoven is polyethylene, polypropylene, polyester, or any combinations thereof. In a preferred exemplary embodiment, bottom layer 14 is made of spunbonded polypropylene. In another preferred embodiment, bottom layer 14 is made of a perforated polyethylene or perforated polypropylene. Bottom layer 14 can also be a hydrophilic nonwoven material, or treated with a surfactant or other hydrophilic material, to permit liquid uptake into tissue layers 17 and laminate 19. Alternatively, bottom layer 14 can be made of coffee filter tissue (CFT). The CFT can be a 16.5-pound white crepe paper that is about 99.5% softwood pulp, where “softwood pulp” means a pure virgin wood pulp that has never been processed. The softwood pulp can be bleached or unbleached. CFT can also contain about 0.5% of a wet-strength resin to give strength to the cellulosic fibers of the CFT when wet. An example of a wet-strength resin includes, but is not limited to, polyamide-epichlorohydrin (PAE) resin.

As noted above, absorbent pad 10 is sealed around its periphery at edges 15. In an exemplary embodiment, the sealed portion is about a half-inch (0.5″) (1.3 cm) around each edge 15. However, the amount of edge 15 that is sealed can vary in size to be more or less than 0.5″.

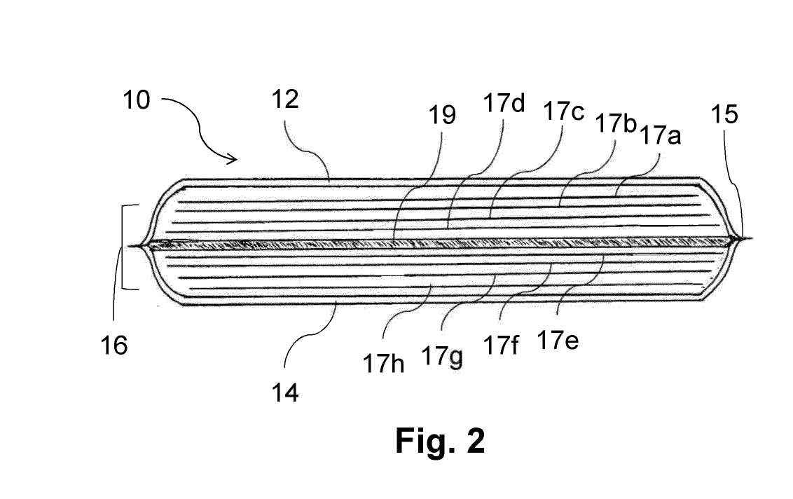

Absorbent body 16 is made of one or more layers of an absorbent material or a superabsorbent material. Absorbent body 16 absorbs liquids exuded from a food product that is placed on absorbent pad 10, and/or condensation in the container that forms while cooling the food product during storage or transport. Absorbent body 16 is preferably made of an absorbent material that is one or more layers of tissue 17 (tissue 17 means either one or all layers of tissue, each separate layer being shown in FIG. 2 as 17a to 17h). Each tissue layer 17 is a sheet of cellulose tissue, and can itself be formed of one or more individual tissues that are joined together to form the tissue layer. The number of tissue layers 17, as well their arrangement in the pad architecture of absorbent pad 10, can vary to regulate the absorption for the absorbent pad, as well as to regulate activation of any active agents therein. Besides tissue, the absorbent material can also be fluff pulp, cellulosic material, binding fiber, airlaid, nonwoven, woven, polymer, absorbent gels, compressed composite with short or microfiber materials, thermoplastic polymer fibers, cellulose powders, or any combinations thereof. Examples of a superabsorbent material includes, but are not limited to, polyacrylates or carboxymethyl starch (CMS), superabsorbent polymer (SAP), compressed SAP, composite of SAP granules adhered with binder or plasticizer, airlaid with SAP, or a starch-based superabsorbent material, such as BioSAP™ (Archer-Daniels Midland, Decatur, Ill.), which is biodegradable and compostable. The nonwoven material can be spunbonded polypropylene or perforated plastic films.

The absorbency of the absorbent material and/or superabsorbent material and/or laminate 19 in absorbent body 16 is typically from about 20 grams to about 80 grams for absorbent pad 10 having outer dimensions of about 3½″ by about 6″, where “absorbency” means the weight of liquid that can be absorbed by absorbent pad 10. More preferably, the total absorbency of absorbent pad 10 is from about 30 grams to about 50 grams. Still more preferably, the total absorbency of absorbent pad 10 is from about 34 grams to about 40 grams, with an average absorbency of about 37 grams. Stated another way, the liquid absorbed for a pad can be measured in terms of grams per square inch (GSI). For instance, for the pad that is 3½″ by about 6″, the area is 21 sq. in., and the absorbency would be about 0.95 GSI to about 3.81 GSI for absorbent pad 10. As another example, assume the pad is 5″×2.5″, we have an area of 12.5 sq. in., and the absorbency would be about 1.5 GSI to about 6.5 GSI for absorbent pad 10.

As described above, absorbent body 16 is preferably slightly smaller than the overall outer dimensions of absorbent pad 10, so that top layer 12 and bottom layer 14 can be more easily sealed around edges 15. In an exemplary embodiment, absorbent body 16 is about five inches (5″) (12.7 cm) in length by about two and a half inches (2.5″) (6.4 cm) in width, in absorbent pad 10 having overall outer dimensions of six inches (6″) (15.2 cm) in length by about three and a half inches (3.5″) (8.9 cm) in width, thereby leaving about 0.5 inches (0.5″) (1.3 cm) perimeter around all four edges 15 of absorbent pad 10 for sealing. Absorbent pad 10 can have outer dimensions and be of a shape that accommodates the shapes and footprint of the food packages.

Absorbent pad 10 preferably includes a laminate 19 positioned between top layer 12 and bottom layer 14. When present, laminate 19 is preferably a part of absorbent body 16, along with tissue layers 17 and/or other absorbent material. Alternatively, laminate 19 can be the entire absorbent body 16. Laminate 19 is made of one or more plies of a cellulosic material, an adhesive (such as glue) or binder, and preferably includes an active agent. In an exemplary embodiment of absorbent pad 10 of the present disclosure, laminate 19 is a mixture of cellulosic material and activated carbon.

In another exemplary embodiment, laminate 19 is a mixture of cellulosic material, activated carbon, and an antimicrobial. In a preferred embodiment, the antimicrobial is an organic acid or combination of organic acids.

Laminate 19 offers several advantages for absorbent pad 10. First, laminate 19 can incorporate large amounts of an active agent in a relatively thin structure, while avoiding the disadvantages of having large amounts of dry, loose chemicals that can cause absorbent pad 10 to “bulge” or have active agents that collect disproportionately in one portion of the absorbent pad when the absorbent pad is picked up by one edge. Second, because an active agent can be uniformly distributed in laminate 19, selecting a prescribed length and number of plies of the laminate permits the total amount of active agent to be determined with certainty. An exemplary embodiment of laminate 19 is a cellulosic material and activated carbon that is uniformly distributed therein to form one or more plies of the laminate.

Absorbent pad 10 can have or contain from about 0.005 grams/square inch (g/in²) to about 0.02 g/in², which is from about 0.005 grams of activated carbon (C*) to about 5.0 g of activated carbon (C*). This amount of activated carbon can be uniformly distributed in the plies of laminate 19. More preferably, absorbent pad 10 has from about 0.05 grams to about 3.0 grams of activated carbon. Still more preferably, absorbent pad 10 has about 0.01 grams to about 2.0 grams of activated carbon. The specific amounts of the active agent/active system and its position in relation to the absorbent material of absorbent body 16 can be selected depending on the size of absorbent pad 10 and the type and quantity of the food product that is being packaged. An advantage of incorporating large amounts of active agent in laminate 19 is the large reservoir of active agent that is available for “extended release” of the active agent, or “extended availability” (of activated carbon) over time.

In a preferred embodiment, absorbent pad 10 has an active agent that is an activated carbon and an antimicrobial agent (or a mixture of antimicrobial agents) that prevents degradation of the food product by microorganisms. The active agent can be disposed in absorbent body 16.

Activated carbon is a solid, highly porous material that attracts, adsorbs and traps volatile organic compounds on its surface. Activated carbon is distinguished from elemental carbon by the removal of all non-carbon impurities and the oxidation of the carbon surface, and generally is manufactured by a two-step process (carbonization [charring] followed by oxidation). In one method, activated carbon particles used in absorbent pad 10 are created by heating a carbonaceous material (e.g., corn cobs, coconut husks) to 600-900° C. in N₂ or Ar (i.e., in the absence of O₂), resulting in a carbon char, or by treating the carbonaceous material with H⁺/OH⁻ or CaCl₂/ZnCl₂ and heating to 450-900° C. (for less time). This treatment forms a microporous structure having interconnected pores, for which 1 gram of activated carbon has a surface area of 500-1500 m²/g, which is approximately 1/10 to 3/10 the area of a football field. As pertains to this disclosure, the very large surface area of activated carbon adsorbs and traps odor-causing organic compounds in part through its interactions with double bonds, and so functions as a deodorizer.

As used in this application, “activated carbon,” “active carbon,” “activated charcoal,” and “amorphous carbon” are synonymous, and these terms are used interchangeably herein without a change in meaning.

Activated carbon largely adsorbs, as opposed to absorbs, molecules of organic compounds. Adsorption is a process by which molecules adhere to the surface only. Absorption, by contrast, is analogous to a sponge that soaks up water, in which the absorbed water is fully integrated into the sponge. As noted above, activated carbon has a very large surface area because it is porous material and has an interconnected network of pores. Activated carbon adsorbs molecules of odor-causing organic compounds, for example, as these compounds “stick” to the surface of the carbon particles along this very large surface area.

Activated carbon has a very large surface area and pore volume that gives it a unique adsorption capacity. Commercial grade activated carbon for food products has a surface area that ranges between 300 and 2,000 m²/g, and some have surface areas as high as 5,000 m²/g. The activity of activated carbon is usually divided into (1) absorption; (2) mechanical filtration; (3) ion exchange; and (4) surface oxidation. Adsorption occurs when components of the gas or liquid attach to a solid (i.e., activated carbon). This attachment can be either physical or chemical, and frequently involves both. Physical adsorption involves the attraction by electrical charge differences between the adsorbent and the adsorbate. Chemical adsorption is the product of a reaction between the adsorbent and the adsorbate.

Confinement odor is caused by microbial activity acting on the food product and in part by enzymatic reactions within the food. There are many compounds associated with tissue breakdown of food products by microbes. Carbohydrates in vacuum-packaged food products break down anaerobically into various carboxylic acids (e.g., lactic acid, acetic acid, and formic acid) and alcohols, typically ethanol. Proteins in vacuum-packaged food products break down into a number of volatile organic sulfur (sulfur, hydrogen sulfide, methanethiol, dimethyl sulfide, dimethyl disulfide, dimethyl trisulfide, and dimethyl tetrasulfide) and nitrogen (ammonia, trimethylamine, indole, cadaverine, putrescine and thiazoles). The qualitative description of the odor often depends on the food product. For beef and poultry products, confinement odor generally has a sulfurous odor, particularly where the pH is high inside the package. For other types of vacuum-packaged foods, confinement odor is described as having a cheese odor or sour milk odor.

The breakdown products of amino acids, either by anaerobic bacteria or enzymes. Volatile Organic Sulfur Compounds (VOSCs) come from breakdown of the amino acids cysteine and methionine. Volatile Organic Nitrogen Compounds (VONCs) can come from breakdown of any of the amino acids.

The carbohydrate breakdown products are more pertinent to fruits and vegetables than proteins.

Activated carbon adsorbs these organic and inorganic compounds formed by breakdown of carbohydrates and/or proteins, including organic acids, alcohols, aldehydes, mercaptans, and amines that can cause confinement odor.

An example of an antimicrobial agent in absorbent pad 10 is a mixture of citric acid and sorbic acid. However, any food-safe antimicrobial can be employed, including, but not limited to, organic acids (that include, but are not limited to, citric acid, sorbic acid, lactic acid, ascorbic acid, oxalic acid, tartaric acid, acetic acid, and any combinations thereof), inorganic acids (such as boric acid), quaternary ammonium compounds, and any combinations of such antimicrobials.

The ratio of the amounts of citric acid to sorbic acid in the antimicrobial affects performance as an inhibitor of bacterial growth in purge. Consistent inhibition of bacterial growth in liquid purge can be obtained with a ratio of 7:3 of citric acid:sorbic acid. In addition, total amounts of the antimicrobial agent can be advantageously scaled to the total absorbency of absorbent pad 10. For example, an embodiment of absorbent pad 10 with absorbent tissue layers 17 and laminate that can absorb about 50 grams of liquid purge can employ about 1.0 gram total of a mixture of citric acid and sorbic acid (at a 7:3 ratio, that is 0.7 g of citric acid and 0.3 g of sorbic acid), which is about 2.0 weight % (wt %), based on the nominal absorbency of the absorbent pad, for consistent inhibition of bacterial growth in liquid purge. For a different embodiment having a nominal absorbency of about 40 grams, the amount of the antimicrobial in laminate 19 is about 0.83 grams total (at a 7:3 ratio, that is about 0.58 grams of citric acid and about 0.25 grams of sorbic acid), which is about 2.1 wt %, based on the nominal absorbency of the absorbent pad.

Other active agents that can be used in absorbent pad 10, include, but are not limited to, an ethylene scavenger, CO₂ generating system, chlorine dioxide (ClO₂), O₂ scavenger, or any combinations thereof, which can be used with activated carbon and/or an antimicrobial.

An exemplary embodiment of a CO₂ generation system is an acid and a base, such as citric acid and sodium bicarbonate, respectively, that react with each other (when activated by water or other liquid) to generate CO₂ gas. The acid component of the CO₂ generation system can be a food-safe organic acid (that includes, but is not limited to, citric acid, sorbic acid, lactic acid, ascorbic acid, oxalic acid, tartaric acid, acetic acid, and any combinations thereof) and inorganic acids (such as boric acid). The ratio and amounts of acid and base, as well as their physical placement in the pad architecture, can be varied to control the timing and amount of CO₂ released. In one exemplary embodiment, citric acid and sodium bicarbonate are present in absorbent body 16 in a ratio of about 4:6, which can be activated by moisture and/or other food exudates to generate CO₂ gas. Citric acid provides an additional benefit by interacting with the sodium ion of sodium bicarbonate to create a citric acid/sodium citrate buffer system that helps maintain a pH that is food-compatible. Other acids can be selected for a CO₂ generation system, with amounts and ratios adjusted in accordance with the pKₐ of the acid. Examples of an ethylene inhibitor or ethylene competitor agents include, but are not limited to, 1-methylcyclopropene, (also called “MCP” or “1-MCP”), its salts and chemical derivatives. The one or more ethylene competitor agents can be selected to bind either reversibly or irreversibly to the ethylene receptors. Examples of an oxygen scavenging system is any enzyme that includes, but is not limited to, glucose oxidase, catalase, lactase, oxidoreductase, invertase, amylase, maltase, dehydrogenase, hexose oxidase, oxygenase, peroxidase, cellulase, and any combinations thereof. Other examples of an oxygen scavenging system include an oxidizable metal, including, but not limited to, iron, zinc, copper, aluminum, tin, and any combinations thereof.

In an exemplary embodiment, absorbent pad 10 has activated carbon and an oxygen scavenging enzyme. The activated carbon and oxygen scavenging enzyme can be disposed in absorbent body 16. In a preferred exemplary embodiment, absorbent pad 10 has activated carbon and the oxygen scavenging enzyme(s) glucose oxidase and/or catalase.

In yet another exemplary embodiment, absorbent pad 10 has activated carbon, an oxygen scavenging enzyme, and an antimicrobial agent. The activated carbon, oxygen scavenging enzyme, and antimicrobial agent can be disposed in absorbent body 16. In a preferred exemplary embodiment, absorbent pad 10 has activated carbon, oxygen scavenging enzyme(s) glucose oxidase and/or catalase, and the antimicrobial agent(s) citric acid and/or sorbic acid.

For those embodiments of absorbent pad 10 having an oxygen scavenger enzyme, absorbent pad 10 can have additional agents. An example of an additional agent is sodium bicarbonate to regulate pH, since a low pH can impair the activity of the oxygen scavenging enzyme. Also, sodium bicarbonate forms a buffer solution when citric acid is used in absorbent pad 10. Glucose is another example of an additional agent that can be added to absorbent pad 10. Glucose increases the oxygen scavenging capacity of the oxygen scavenging enzyme, such as glucose oxidase.

Enzymatic oxygen scavengers undergo an intermediate step where H₂O₂ is generated, which can also lead to free radicals that can capture and degrade odor-causing compounds. In an alternative embodiment, absorbent pad 10 can include an oxygen scavenging enzyme alone.

Another benefit of having activated carbon in absorbent pad 10 is that activated carbon reduces or eliminates discoloration that may otherwise discolor absorbent pad 10 or the vacuum-packaged food product.

Each active agent/active system can be positioned in a pocket in absorbent pad 10 that is formed by: any two tissue layers 17; any tissue layer 17 and laminate 19; topmost tissue layer 17 and top layer 12; and/or bottommost tissue layer 17 and bottom layer 14. Alternatively, an active agent can be incorporated in one or more plies of laminate 19.

Referring to FIG. 2, the exemplary embodiment of absorbent pad 10 has top layer 12 that is a polyethylene film, and bottom layer 14 that is a nonwoven. In the embodiment in FIG. 2, absorbent body 16 has a total of eight tissue layers 17, with four tissue layers disposed above laminate 19 and four tissue layers disposed below laminate 19. One tissue layer 17a is adjacent to top layer 12, and another tissue layer 17d is adjacent to laminate 19. In this embodiment, laminate 19 is a cellulosic material, such as crepe tissue, and includes activated carbon, an antimicrobial agent that is citric acid and/or sorbic acid, and glue to hold the laminate together. Another tissue layer 17h is positioned below laminate 19 and adjacent to bottom layer 14.

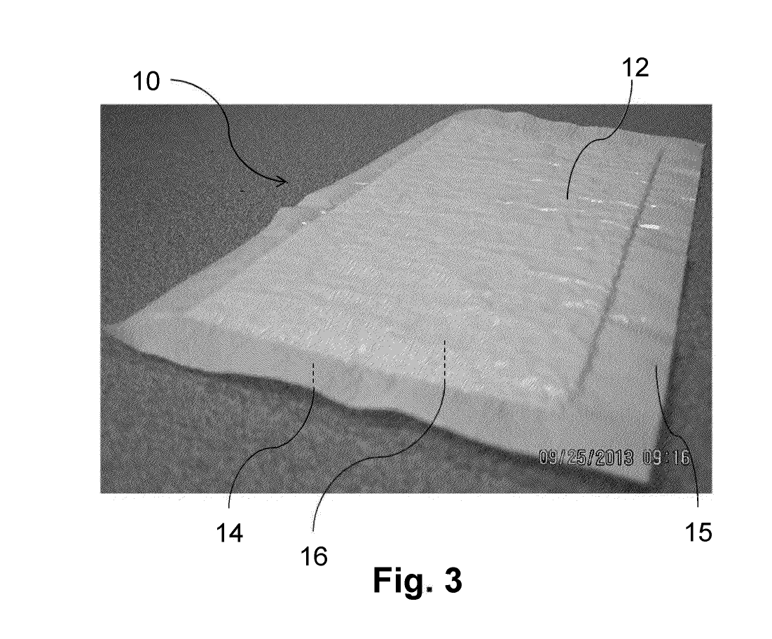

FIG. 3 is an exemplary embodiment of absorbent pad 10, showing top layer 12, bottom layer 14, and edges 15 around the periphery of absorbent pad 10 where top layer 12 and bottom layer 14 are joined and sealed to enclose absorbent body 16.

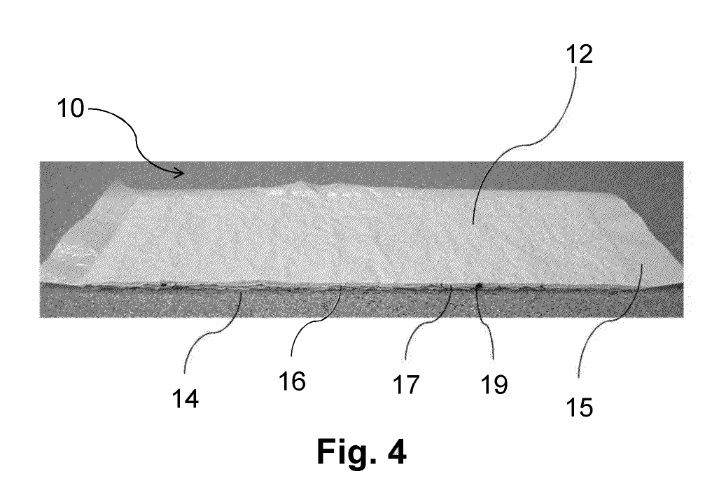

FIG. 4 is the absorbent pad 10 in FIG. 3 that has been cut in half along its longitudinal axis to reveal the interior structures of the absorbent pad, including absorbent body 16, tissue layers 17, and laminate 19. Top layer 12, bottom layer 14, and edges 15 around the periphery of absorbent pad 10 where top layer 12 and bottom layer 14 are joined to enclose and seal absorbent body 16 are also shown.

As used in this application, the “pad architecture” of absorbent pad 10 means the structure and order of individual tissue layer(s) 17, laminate 19, the top and bottom layers 12 and 14, respectively, or any active agents therein. “Regulation” means controlling the speed, location, and amount of liquid absorption, as well as controlling activation speed and duration of release of active agents. Thus, varying the pad architecture can be used to regulate uptake of liquids exuded by a food product on absorbent pad 10, and regulate activation, rate of release, and duration of the active agent. A pad architecture that physically separates the individual chemical components of an active agent with tissue layers can be selected to delay activation and/or provide an “extended release” of the active agent contained in absorbent pad 10. For example, positioning a larger number of tissue layers 17 above and/or below laminate 19 can delay activation and extend release of an active agent in laminate 19. In an exemplary embodiment shown in FIG. 2, positioning four tissue layers 17a, 17b, 17c, 17d above and four tissue layers 17e, 17f, 17g, 17h below laminate 19 can delay activation, and also serve as a reservoir for extended release or extended availability of the activated carbon and/or antimicrobial agent in laminate 19.

As used in this application, “scaling,” means selecting the proper amounts of active agent in relation to the amount of absorbent material and the type of food product being packaged. Scaling is critical to the performance of absorbent pad 10. Some food products produce very little moisture or liquid exudates (also called “purge” in this application) that would be available to activate the active agent, while other food products produce a large amount of moisture or liquid exudates. For example, if absorbent pad 10 has too many tissue layers 17 relative to the amount of liquid purge, there may be insufficient liquid to dissolve the active agent(s) for their activation. Conversely, too few tissue layers 17, combined with a large volume of liquid purge, can dilute or even “drown” the active agent, thereby impairing its effectiveness. In addition, the number, size, and placement of apertures 18 in absorbent pad 10 can be considered for scaling.

The amount of active agent in the pad architecture of absorbent pad 10 of the present disclosure for a given food package can also be tailored depending on several factors, including, but not limited to: the total volume of the food package; the amount of the food product in the individual food package (i.e., how much volume the food product occupies); how much of the active agent is expected to be lost; and other physical factors, such as temperature and pressure. Likewise, as noted above, the pad architecture can be tailored to regulate the rate of release of the active agent. For example, using a pad architecture where portions of the active agent are physically separated can provide a sustained release of an active agent (such as an antimicrobial) to provide maximum capacity of the active agent in the food package.

Absorbent pad 10 disclosed herein can be used in vacuum-packed food packages to reduce confinement odor, extend shelf life and food freshness, and to enhance the appearance of vacuum-packaged food products.

Confinement odor is a particular problem for vacuum-packaged food products because of its special packaging requirements. A conventional food package typically uses a breathable, semi-permeable thin film that allows some of the CO₂, O₂, as well as odor-causing volatile organic compounds to gradually escape the food package. In addition, the conventional food package has a certain amount of headspace between the food product and the breathable film in which dissolved volatile organic compounds in solution can establish equilibrium in the gas phase and, from there, slowly escape the food package through the breathable film. By contrast, vacuum-packaged food products require a thicker plastic film that is largely impermeable to gases and acts as a barrier film, and does not permit the slow escape of CO₂, O₂, and volatile organic compounds out of the package. Also, vacuum-packaged food products have very little or no headspace in which any dissolved volatile organic compounds can establish an equilibrium in gas phase, and so the volatile organic compounds are trapped in the liquid until the vacuum-packaged food product is opened by the consumer, causing the dissolved volatile organic compounds to rapidly transition into a gas (analogous to opening a bottle of a carbonated beverage) and their release into the air, where these volatile compounds are perceived as confinement odors by the consumer.

The pad architecture of absorbent pad 10 has the benefit that the absorbent body (e.g., tissue layers) actively “draw in” the liquid purge from the food product, along with the breakdown products dissolved in the liquid purge, into contact with the activated carbon in the pad, much like an electric fan force air through an air filter containing activated carbon to rapidly clear impurities in a room. The drawing action of absorbent pad 10 increases the rapidity and extent by which the activated carbon contacts and adsorbs the odor-causing compounds, thereby reducing or eliminating confinement odor altogether when the vacuum-packaged food package is opened by the consumer.

Still further, in those embodiments of absorbent pad 10 that contain activated carbon and an antimicrobial agent (such as a combination of citric acid and sorbic acid) confinement odor is reduced or eliminated by two separate mechanisms of action. The antimicrobial agent kills or inhibits growth of microbes, such as bacteria, that cause degradation and breakdown of proteins and carbohydrates. However, even an antimicrobial cannot stop all decay and degradation of carbohydrates and proteins. In those instances where breakdown products are formed, the lack of headspace causes these breakdown products to be dissolved or otherwise trapped in the liquid purge, which is drawn into the absorbent pad and held in contact with the activated carbon, which adsorbs these breakdown products, rapidly, and completely.

By this dual mechanism of action, when the vacuum-packaged food product is opened by the consumer, the odor-causing compounds are trapped by the activated carbon and so are unavailable to rapidly enter the gas phase in the ambient environment, where they would otherwise be detected as confinement odor by the consumer.

### EXPERIMENTAL

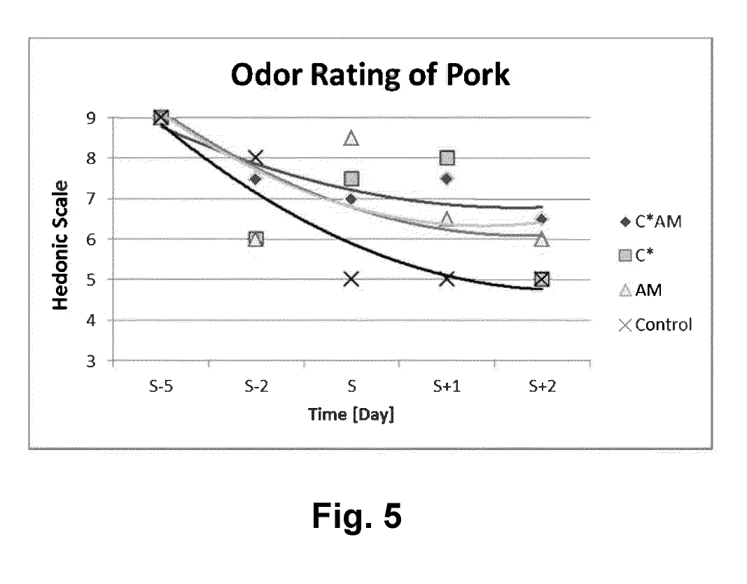

FIG. 5 and Table 2 show the results of a test of several exemplary embodiments of absorbent pad 10 on the “odor rating” of vacuum-packaged pork chops, as follows:
(1) Absorbent pad 10 having activated carbon and an antimicrobial agent that is a mixture of citric acid and sorbic acid in a 7:3 ratio (“C*AM”);
(2) Absorbent pad 10 having activated carbon only (“C*”);
(3) Absorbent pad 10 having an antimicrobial agent of a mixture of citric acid and sorbic acid in a 7:3 ratio (“AM”); and
(4) Control absorbent pad, with no activated carbon or antimicrobial agent (“Control”).

Each pork chop was examined, smelled and touched to measure color, odor, and texture to touch on each test day. Hedonic scale ranges were from 1 to 9, with 9 being the highest value, 5 being borderline for consumer acceptability, and 1 being completely unacceptable in the panel's judgment, as summarized in Table 1.

TABLE 1
Criteria Applied for Judging Sensory Characteristics

| | | | | Overall |
|---|---|---|---|---|
| | Color | Odor | Texture | acceptability |
| 9 | dark purplish | normal fresh odor | creamy white | extremely |
| | red | | | desirable |
| 8 | | | | |
| 7 | pink | normal meat odor | mostly creamy | Desirable |
| | | | white | |
| 6 | | | | |
| 5 | light pink | aged odor | tan | borderline |
| | | | | acceptable |
| 4 | | | | |
| 3 | grayish pink | slight | moderately | slightly |
| | | objectionable odor | brown | undesirable |
| 2 | | | | |
| 1 | pale light white | spoiled odor | dark brown or | extremely |
| | | | green | undesirable |

The results of the test are summarized in Table 2 and in FIG. 5. On the x-axis, “S” is the “sell by date,” so the test samples were vacuum-packaged 5 days before the sell-by date (i.e., S−5). The absorbent pad 10 having the antimicrobial laminate with activated carbon (C*AM) maintained a fresher smell, longer than the other embodiments of the absorbent pad with actives (C*, and AM) and the Control pad that were tested.

TABLE 2
Test Data for Vacuum Packaged Park Chops
Vacuum Packaged Pork Chops

| | | Activated Carbon and | | | | | | | | | | | | | | | |
|---|---|---|---|---|---|---|---|---|---|---|---|---|---|---|---|---|---|
| Storage | | Antimicrobial (C* AM) | | | | Activated Carbon (C*) | | | | Antimicrobial (AM) | | | | Control | | | |
| time | | | | Fat | | | | Fat | | | | Fat | | | | Fat | Over- |
| (days) | | Color | Odor | Color | Overall | Color | Odor | Color | Overall | Color | Odor | Color | Overall | Color | Odor | Color | all |
| S − 5 | rep | | | | | | | | | | | | | | | | |
| | 1 | | | | | | | | | | | | | | | | |
| | rep | | | | | | | | | | | | | | | | |
| | 2 | | | | | | | | | | | | | | | | |
| | mean | 9 | 9 | 9 | 9 | 9 | 9 | 9 | 9 | 9 | 9 | 9 | 9 | 9 | 9 | 9 | 9 |
| | std | | | | | | | | | | | | | | | | |
| | dev. | | | | | | | | | | | | | | | | |
| S − 2 | rep | 8 | 8 | 8 | 8 | 8 | 6 | 8 | 7 | 8 | 7 | 8 | 8 | 8 | 8 | 8 | 8 |
| | 1 | | | | | | | | | | | | | | | | |
| | rep | 6 | 7 | 8 | 7 | 7 | 6 | 8 | 7 | 8 | 5 | 8 | 6 | | | | |
| | 2 | | | | | | | | | | | | | | | | |
| | mean | 7.0 | 7.5 | 8.0 | 7.5 | 7.5 | 6.0 | 8.0 | 7.0 | 8.0 | 6.0 | 8.0 | 7.0 | 8.0 | 8.0 | 8.0 | 8.0 |
| | std | 1.4 | 0.7 | 0.0 | 0.7 | 0.7 | 0.0 | 0.0 | 0.0 | 0.0 | 1.4 | 0.0 | 1.4 | | | | |
| | dev. | | | | | | | | | | | | | | | | |
| S | rep | 7 | 6 | 7 | 7 | 8 | 8 | 8 | 8 | 7 | 9 | 8 | 8 | 7 | 6 | 8 | 6 |
| | 1 | | | | | | | | | | | | | | | | |
| | rep | 8 | 8 | 8 | 8 | 8 | 7 | 8 | 7 | 8 | 8 | 7 | 8 | 8 | 4 | 8 | 5 |
| | 2 | | | | | | | | | | | | | | | | |
| | mean | 7.5 | 7.0 | 7.5 | 7.5 | 8.0 | 7.5 | 8.0 | 7.5 | 7.5 | 8.5 | 7.5 | 8.0 | 7.5 | 5.0 | 8.0 | 5.5 |
| | std | 0.0 | 0.0 | 1.0 | 0.0 | 0.0 | 0.0 | 0.0 | 0.0 | 0.0 | 0.0 | 0.7 | 0.0 | 0.0 | 0.0 | 0.0 | 0.0 |
| | dev. | | | | | | | | | | | | | | | | |
| S + 1 | rep | 8 | 8 | 8 | 8 | 8 | 8 | 8 | 8 | 8 | 7 | 8 | 8 | 6 | 5 | 5 | 5 |
| | 1 | | | | | | | | | | | | | | | | |
| | rep | 6 | 7 | 8 | 7 | 8 | 8 | 8 | 8 | 7 | 6 | 8 | 7 | 6 | 5 | 4 | 5 |
| | 2 | | | | | | | | | | | | | | | | |
| | mean | 7.0 | 7.5 | 8.0 | 7.5 | 8.0 | 8.0 | 8.0 | 8.0 | 7.5 | 6.5 | 8.0 | 7.5 | 6.0 | 5.0 | 4.5 | 5.0 |
| | std | 1.4 | 0.7 | 0.0 | 0.7 | 0.0 | 0.0 | 0.0 | 0.0 | 0.7 | 0.7 | 0.0 | 0.7 | 0.0 | 0.0 | 0.7 | 0.0 |
| | dev. | | | | | | | | | | | | | | | | |
| S + 2 | rep | 8 | 6 | 8 | 7 | 5 | 5 | 6 | 5 | 8 | 6 | 8 | 8 | 7 | 5 | 7 | 6 |
| | 1 | | | | | | | | | | | | | | | | |
| | rep | 6 | 7 | 6 | 6 | 7 | 5 | 8 | 6 | 7 | 6 | 7 | 7 | 6 | 5 | 6 | 5 |
| | 2 | | | | | | | | | | | | | | | | |
| | mean | 7.0 | 6.5 | 7.0 | 6.5 | 6.0 | 5.0 | 7.0 | 5.5 | 7.5 | 6.0 | 7.5 | 7.5 | 6.5 | 5.0 | 6.5 | 5.5 |
| | std | 1.4 | 0.7 | 1.4 | 0.7 | 1.4 | 0.0 | 1.4 | 0.7 | 0.7 | 0.0 | 0.7 | 0.7 | 0.7 | 0.0 | 0.7 | 0.7 |
| | dev. | | | | | | | | | | | | | | | | |

While the antimicrobial appears to do most of the work to reduce confinement odor, the activated carbon and the antimicrobial agent appear to work synergistically to reduce confinement odor and spoilage odor.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances that fall within the scope of the disclosure.

What is claimed is:

1. An absorbent food pad for use in a vacuum-packed or shrink-wrapped product having food therein comprising:
a top layer;
a bottom layer; and
a laminate positioned between the top layer and the bottom layer,
wherein the laminate includes an active agent,
wherein the laminate reduces confinement odor in the vacuum-packed or shrink-wrapped product.

2. The absorbent food pad of claim 1, wherein the active agent is activated carbon.

3. The absorbent food pad of claim 2, wherein the activated carbon is in an amount from about 0.005 grams per square inch to about 0.02 grams per square inch.

4. The absorbent food pad of claim 2, wherein the activated carbon has a surface area ranging between 300 m²g and 5000 m²g.

5. The absorbent food pad of claim 2, wherein the absorbent food pad further includes an oxygen scavenger.

6. The absorbent food pad of claim 5, wherein the laminate includes the oxygen scavenger.

7. The absorbent food pad of claim 6, wherein the oxygen scavenger is glucose oxidase and/or catalase.

8. The absorbent food pad of claim 2, wherein the absorbent food pad further includes an antimicrobial agent.

9. The absorbent food pad of claim 8, wherein the laminate includes the antimicrobial agent.

10. The absorbent food pad of claim 8, wherein the antimicrobial agent is a mixture of citric acid and sorbic acid.

11. The absorbent food pad of claim 10, wherein the citric acid and sorbic acid are present at a ratio of 7 to 3.

12. The absorbent food pad of claim 10, wherein the antimicrobial agent is about 2.0 weight % based on nominal absorbency of the absorbent food pad.

13. The absorbent food pad of claim 2, wherein the absorbent food pad has a total absorbency from about 0.95 grams per square inch to about 6.5 grams per square inch.

14. The absorbent food pad of claim 2, wherein the laminate is made of two or more plies of a cellulosic material.

15. The absorbent food pad of claim 14, wherein the active agent is incorporated into the two or more plies of the laminate.

16. The absorbent food pad of claim 2, wherein the top layer is a film having a thickness of about 0.65 mil.

17. An absorbent food pad for use in a vacuum-packed or shrink-wrapped product having food therein comprising:
a top layer;
a bottom layer; and
a laminate positioned between the top layer and the bottom layer,
wherein the laminate includes a plurality of active agents, the plurality of active agents comprising activated carbon, an antimicrobial agent, and an oxygen scavenger,
wherein the laminate reduces confinement odor in the vacuum-packed or shrink-wrapped product.

18. The absorbent food pad of claim 17, wherein the antimicrobial agent is a mixture of citric acid and sorbic acid.

19. The absorbent food pad of claim 17, wherein the oxygen scavenger is glucose oxidase and/or catalase.

20. A system to reduce confinement odor in food packages, the system comprising:
a food package that is vacuum-packed or shrink-wrapped;
a food product positioned in the food package; and
an absorbent food pad positioned in the food package, the absorbent food pad having an architecture comprising:
a top layer;
a bottom layer; and
a laminate positioned between the top layer and the bottom layer, wherein the laminate includes a plurality of active agents that reduce confinement odor when the food package is opened, the plurality of active agents comprising activated carbon, an antimicrobial agent, and an oxygen scavenger, wherein the antimicrobial agent is a mixture of citric acid and sorbic acid, and wherein the oxygen scavenger is glucose oxidase and/or catalase.
